(19) United States
(12) Patent Application Publication
(10) Pub. No.: US 2023/0256715 A1
(43) Pub. Date: Aug. 17, 2023

(54) LAMINATED GLAZING

(71) Applicant: Pilkington Group Limited, Nr. Ormskirk Lancashire (GB)

(72) Inventor: Peter Paulus, Muenster (DE)

(73) Assignee: Pilkington Group Limited, Nr. Ormskirk Lancashire (GB)

(21) Appl. No.: 18/004,740

(22) PCT Filed: Jul. 9, 2021
(86) PCT No.: PCT/GB2021/051774

§ 371 Date: Jan. 9, 2023

(30) Foreign Application Priority Data
Jul. 10, 2020 (GB) 2010633.2

(51) Int. Cl. B32B 17/10

(52) U.S. Cl. CPC B32B 17/10036; B32B 17/10137; B32B 17/10247; B32B 2315/08; B32B 2605/00

(57) ABSTRACT

An automotive rear window glazing for installation in a car, comprises at least two plies of glazing material and at least one ply of plastics interlayer material extending between the plies of glazing material, the ply of plastics interlayer material being substantially co-extensive with the plies of glazing material and bonding the plies of glazing material to each other, wherein the ply of plastics interlayer material contains draw lines extending in substantially one direction, the automotive rear window glazing has a top edge and a bottom edge, and wherein the automotive rear window glazing is installed with the draw lines in the plastics interlayer material extending from the top to the bottom edges.

The present invention relates to a laminated glazing, and in particular to a laminated glazing for a vehicle. The laminated glazing may comprise one or more plies of glazing material, usually glass, bonded to one or more plies of a plastics material.

The laminated glazing of the invention is particularly useful for windows which when installed are oriented at a low angle to the horizontal, i.e. a high angle to the vertical, and such windows may be specified in road or rail vehicles. In the case of a road vehicle the laminated glazing of the invention is particularly suited to a car, in which case the laminated glazing may be an automotive rear window glazing (known in the industry as a “backlight”), rooflight or sunroof.

It is of course desirable that the view through a window should be free from distortion, i.e. the view through the window should be an accurate representation of whatever is beyond the window. When one refers to distortion in relation to the view through a window, it is transmitted optical distortion that is meant. In the idealised case of a window glazed with a glazing which is completely free from transmitted optical distortion, the image of an object viewed through the window is indistinguishable from the image of the object viewed directly, i.e. the image is a faithful reproduction of the original. In practice this is not wholly attainable, but glassmakers nevertheless seek to minimise the degree of transmitted optical distortion which is present in a window, so that it is not noticeable to an observer.

Furthermore, it is especially important that the view which a vehicle driver has through the windows of a vehicle is free from distortion for safety reasons, it being self-evident that the driver of a vehicle needs to have an accurate and undistorted view of the external environment. In the case of a road vehicle, it is clear that the driver needs to have an accurate view of the road ahead, but it is also important to be able to form an accurate view of other vehicles behind, so that the driver can judge their position and trajectory, for instance. For all these reasons, glazings which are intended for automotive use are manufactured to strict standards for distortion, amongst other properties, and are carefully inspected to ensure that the level of distortion complies with the relevant standards.

Transmitted optical distortion in a sheet of glass arises when the major surfaces of the glass are not completely parallel to each other, so that local areas of the glass act as lenses, albeit with a very low refractive power. Usually the refractive power varies continuously across the sheet of glass, but with a low value.

Such transmitted optical distortion may result from a variety of causes. For instance, the process by which the sheet of glass is formed may impart distortion to the glass. The process used for forming sheets of glass is usually the float glass process but may also be the overflow downdraw process, also known as the fusion draw process. Subsequent processing, such as shaping the glass, may add further distortion of a different nature. For example, even a momentary pause while conveying hot glass on rollers may be enough to cause the glass to begin to adopt the shape of the rollers, causing the glass to become slightly corrugated.

Laminated glass may comprise at least one ply of glass laminated to at least one ply of a plastics material; such a construction is also termed a bilayer. More commonly, a laminated glass comprises at least two plies of glass and at least one ply of a plastics material, wherein the ply of plastics material extends between the plies of glass and is substantially co-extensive with them, and bonds the plies of glass together. The ply of plastics material may be said to be “sandwiched” between the plies of glass and is frequently described as an interlayer for this reason.

In order to manufacture a laminated glass comprising two plies of glass and a ply of plastics interlayer material, the ply of plastics interlayer material is placed between the plies of glass so that it is co-extensive with them, and air is removed from the assembly by passing it between nip-rollers or by use of a vacuum bag. This process is known as deaeration. The assembly is then placed in an autoclave and subjected to an elevated temperature and pressure to cause the interlayer material to bond to the glass, thereby bonding the plies of glass together and forming a laminate.

In the case of laminated glass comprising two plies of glass, transmitted optical distortion is normally present in both plies of glass and the interlayer, giving rise to a more complex optical situation.

In both the float process and the overflow downdraw or fusion draw process, glass is drawn through the forming stage under slight tension, resulting in a slight unevenness or waviness comprising elongate peaks and troughs which are oriented parallel to the direction of draw. These elongate troughs and peaks give rise to distortion in the form of spaced parallel lines of alternate relative brightness and darkness, or fringes, in the glass, known as draw lines, or in the case of the float process, float lines.

Similarly, when a sheet of plastics interlayer material is manufactured, a wavy unevenness in the thickness of the interlayer material may be formed as a result of the manufacturing process. This unevenness also comprises alternating peaks and troughs, and can again give rise to distortion in the form of spaced parallel lines of alternate relative brightness and darkness in a laminated glass made with the interlayer material, which are also known as draw lines. For example, the unevenness causing draw lines may result from extrusion of the sheet through an extrusion nozzle or die, or from stresses in the interlayer material, e.g. from stretching or cooling of the material. The elongate troughs and peaks causing these draw lines are again aligned with the direction of elongation parallel to the direction of draw.

Given the importance of an undistorted view of the road ahead for the driver of a road vehicle, it is not surprising that the background art pays particular attention to alleviating distortion in windscreens. For instance, U.S. Pat. No. 3,700,542 discloses a method of making safety windshields from two glass sheets so that distortion lines in one glass sheet are oriented at an angle with respect to distortion lines in the second glass sheet.

In comparison, U.S. Pat. No. 4,093,438 teaches a method of making laminated windshields in which the draw lines of the glass are aligned vertically. This orientation is said to reduce draw line distortion observable when the windshield is in place in the vehicle.

US 2020/156352 (derived from WO 2018/215082) discloses a laminated glazing comprising at least one pane and also a thermoplastic film, each of which has a plurality of elongate raised elements and elongate sunken elements. In the laminated glazing, the elongate elements of the pane are arranged at an angle other than 900 from the elongate elements of the thermoplastic film. The invention is said to be especially useful for a windscreen, and indeed a windscreen is described in the specification and illustrated in FIG. 5.

However, as previously mentioned, it is also important for the driver of a vehicle to have a clear and undistorted view behind the vehicle. In most cases, the driver obtains a view behind the vehicle through the rear window by means of a rear view mirror, and the direction of view backwards is approximately horizontal.

Although automotive rear window glazings are frequently made from a single sheet of glass, which is toughened, laminated glass is increasingly used for more highly specified cars because it offers greater safety and security, as well as better sound insulation. Also, in recent years, there has been a trend towards designing certain vehicles, especially sports cars and high performance cars, with their rear window glazings (known in the industry as “backlights”) installed at increasingly large angles to the vertical, so that the general orientation of the window itself approaches the horizontal.

Unfortunately, rear window glazings made from laminated glass and installed at such high installation angles may display an undesirably high level of transmitted optical distortion. This is particularly the case when a driver looks through the window by means of the rear view mirror, since the direction of view backwards is at a small angle to the rear window, both being close to horizontal. In other words, the angle of view through the rear window is extremely oblique, which increases the degree of refraction that occurs at the surfaces of the window, and therefore increases the effect of any distortion present in the window. Furthermore, at such an oblique angle, light arriving at the driver's eyes from behind the vehicle will have travelled along a much longer path through the rear glazing than when the angle of view is normal to the glazing, when the path length is of course at a minimum. This may also increase the amount of distortion which occurs.

It has now been realised that variation in the thickness of the interlayer, more specifically draw lines, contributes substantially to transmitted optical distortion in this situation. This realisation is particularly applicable to automotive rear window glazings which are installed in cars at large angles to the vertical, as described above. Previously, attention had focussed on the glass as the main source of optical distortion in a laminated glass, it having been thought that any unevenness in the interlayer would disappear as it flowed under temperature and pressure during autoclaving.

According to the present invention there is provided an automotive rear window glazing for installation in a car, comprising at least two plies of glazing material and at least one ply of plastics interlayer material extending between the plies of glazing material, the ply of plastics interlayer material being substantially co-extensive with the plies of glazing material and bonding the plies of glazing material to each other, wherein the ply of plastics interlayer material contains draw lines extending in substantially one direction, the automotive rear window glazing has a top edge and a bottom edge, and wherein the automotive rear window glazing is installed with the draw lines in the plastics interlayer material extending from the top to the bottom edges.

Preferably the glazing material is glass. However, various plastics materials are also used as glazing materials, and may themselves also give rise to draw lines, depending on the manufacturing process used.

It has been the practice to manufacture laminated glazings such as windscreens, side glazings and rear window glazings with the draw lines in the plastics interlayer material extending from side to side when the glazing is installed, i.e. in a generally horizontal direction. There are several reasons for this, which will be briefly summarised.

First, owing to the nature of the process by which interlayer material is manufactured, it is more economic for the manufacturers of interlayer material to supply rolls of interlayer material with a width of approximately 1 metre. Pieces of plastics interlayer material of suitable size and shape for the manufacture of automotive glazings can be cut from a roll of interlayer material 1 metre wide if the pieces are cut with their long axes extending parallel to the direction in which material is unwound from the roll, i.e. longitudinally, along the length of the continuous strip of interlayer material, and parallel to the draw lines in the interlayer material. However, the consequence of this is that the resulting glazing is installed with the draw lines extending in a generally horizontal or side to side direction. Plastics interlayer material is relatively expensive, and this cost would be increased by specifying rolls of greater width.

Secondly, it is standard practice to stretch the plastics interlayer material before cutting it to improve utilisation and reduce cost. This is based on the fact that most windscreens and rear windows are generally trapezoidal in shape, whereas unstretched interlayer material lends itself to being cut into pieces of rectangular shape. Since, from a practical point of view, it is only possible to stretch interlayer material longitudinally and not transversely, this practice again favours cutting pieces of interlayer material with their long axes extending parallel to the direction in which material is unwound from the roll and stretched, i.e. along the length of the continuous strip of interlayer material, and parallel to the draw lines in the interlayer material.

It is only possible to provide a shade band (a dyed portion of the interlayer material) at the top of a windscreen if the piece of interlayer material is cut longitudinally, since it is one edge of the roll of interlayer material which is dyed. However, demand for shade bands is currently reducing.

Thirdly, the occupants of a vehicle look through the windows at a variety of angles as a result of turning their heads from side to side. This is referred to as looking “cross car”, and tends to make optical distortion with a generally vertical orientation more noticeable. By arranging the draw lines to extend from side to side, this effect is reduced, i.e. the distortion is less apparent.

Fourthly, the use of head-up displays (“HUDs”) is increasing in vehicles including cars, and HUDs require a windscreen with a wedged cross-section, i.e. the thickness of the windscreen tapers from bottom to top. Normally, such a wedged cross-section is achieved by using wedged plastics interlayer material. For manufacturing reasons, the wedge or taper in a roll of interlayer material extends side to side, which restricts the direction in which pieces of interlayer can be cut.

For all these reasons it has been accepted practice to manufacture automotive glazings with the draw lines extending side to side, i.e. generally horizontally. However, having realised that this practice contributes substantially to transmitted optical distortion in an automotive rear window glazing, motivation is provided to re-examine and alter this practice. Moreover, the third and fourth reasons above do not apply to rear window glazings, since the occupants of a vehicle do not, as a rule, look cross car through the rear window glazing, and HUDS are not used on rear window glazings. With regard to the third reason, namely distortion seen in cross car view, it has in fact been found that in any case this does not deteriorate as much as expected when the interlayer material is used with its draw lines oriented top to bottom.

Nevertheless, to obtain the advantages in terms of transmitted optical distortion which the present invention offers, it is expected that costs incurred for plastics interlayer material will increase, since it cannot be used so economically when pieces of interlayer are cut transversely rather than longitudinally. In the case of high value premium vehicles with large rear window glazings installed at a high installation angle, the improvement in transmitted optical distortion is sufficient to warrant the additional cost.

Normally one or both of the plies of glazing material contains draw lines, especially if the glazing material is glass. Preferably the draw lines displayed in the plies of glazing material are substantially parallel to the draw lines in the ply of plastics interlayer material, i.e. all the draw lines extend from the top to the bottom edges.

By arranging the draw lines in the glazing material in the same orientation as the draw lines in the plastics interlayer material, transmitted optical distortion is further reduced.

The invention is particularly applicable to an automotive rear window glazing which is installed at an installation angle of 650 or greater, preferably 680 or greater, more preferably 720 or greater, still more preferably 750 or greater, and yet more preferably 780 or greater.

As explained above, the greater the installation angle, the closer in practice the automotive rear window glazing is to being horizontal. Since the direction of view through the glazing is generally approximately horizontal, the degree of transmitted optical distortion displayed in the glazing increases rapidly as the installation angle increases towards 800 or more.

The invention is also particularly applicable to an automotive rear window glazing with at least one ply of thin glass. Preferably the thickness of at least one of the plies of glass or other glazing material is in the range from 0.4 to 1.3 mm, more preferably in the range from 0.5 to 1.1 mm, and still more preferably 0.6 to 0.9 mm. It has been found that transmitted optical distortion is more apparent in thinner glass.

If the plies of glazing material are glass, the safety performance of a laminated automotive rear window glazing may be enhanced by toughening at least one of the plies of glass. Depending on vehicle design, some automotive rear window glazings may be quite large, e.g. over a square metre in surface area, with at least one dimension approaching or even exceeding 1.5 m. This is particularly the case when the rear window glazing is installed at a high installation angle. For reasons of fuel efficiency and performance (e.g. acceleration, braking, cornering and general handling) of a vehicle, it is desirable to reduce the weight of the vehicle wherever possible. A relatively large rear window glazing may possess a significant weight, but this may be reduced by employing one or more thinner plies of glass in the construction of the glazing. Very thin plies of glass, e.g. those less than 1.5 mm thick, are rather fragile unless toughened, and a particularly suitable toughening process for such thin glass is the chemical toughening process. Preferably at least one of the plies is glass which has been chemically toughened, i.e. the glass has been subjected to an ion exchange process in which larger ions replace smaller ions in the glass surface, thereby generating a compressive stress in the surface which increases its resistance to crack propagation.

It should be noted that it is a general practice amongst manufacturers of plastics interlayer material to apply a texture to one or both surfaces of the interlayer material to assist with deaeration during assembly. This texture may also comprise elongate troughs and peaks, however these are on a smaller scale than the troughs and peaks which characterise draw lines. The wavelength of the troughs and peaks provided for deaeration purposes is typically of the order of one or two millimetres, whereas the wavelength of the elongate troughs and peaks of which draw lines are comprised may be considerably greater, of the order of several tens of millimetres, typically 50 mm or more. Preferably, the wavelength of the draw lines displayed in an automotive rear window glazing according to the invention is 50 mm or greater, more preferably 80 mm or greater, and still more preferably 120 mm or greater.

According to another aspect, the invention also relates to a car fitted with an automotive rear window glazing according to the invention. The car may in particular be a high performance car such as a sports car or coupe.

In this specification, references to the top or bottom of an automotive rear window glazing, or the top or bottom edge of the glazing, are to be understood as references to the orientation of the glazing when it is installed in a car. In its installed orientation, the top and bottom edges of the glazing extend generally transversely from one side to the other side of the car. Part, even a substantial part, of the top and bottom edges normally extends horizontally.

The rear window glazing also has at least two side edges which connect the top and bottom edges of the glazing. The orientation of the side edges depends on the installation angle of the glazing, but will always extend in a direction which includes a vertical component.

With reference to the orientation of the glazing in its installed state, draw lines which extend from side to side of a glazing may be said to extend approximately horizontally, and by contrast, draw lines which extend from the top edge to the bottom edge of a glazing may loosely be said to extend vertically, or in a vertical direction, although more precisely it is a direction which has a vertical component but is not perfectly vertical.

The invention will now be further described by way of the following non-limiting specific embodiments, which are illustrated with reference to the accompanying drawings in which:

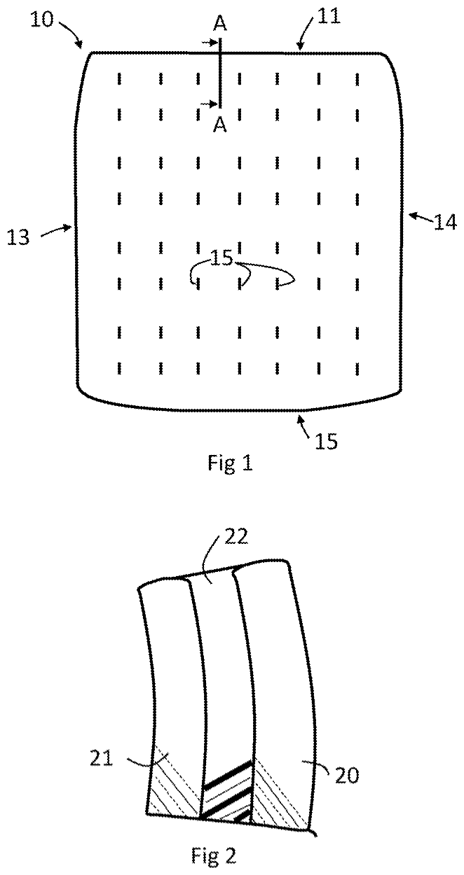

FIG. 1 is a schematic plan view of an automotive rear window glazing;

FIG. 2 is a sectional view taken along the line A-A in FIG. 1, showing part of the automotive rear window glazing, greatly enlarged;

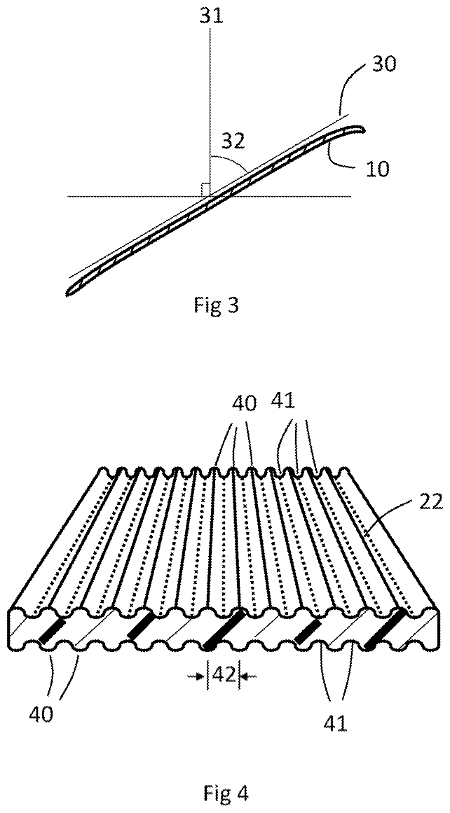

FIG. 3 is a diagram showing the installation angle of an automotive rear window glazing, the glazing being shown in section;

FIG. 4 is a schematic combined perspective and sectional view of a sheet of plastics interlayer material.

Referring to FIG. 1, a schematic plan view of an automotive rear window glazing 10 is shown. The glazing has a top edge 11, a bottom edge 12, and side edges 13 and 14. The shape of the glazing shown is purely schematic, and rear window glazings may have a variety of shapes other than that shown. In general, however, the shape of a rear window glazing is very loosely based on a trapezium, rectangle or square, but with curved edges and corners.

FIG. 2 is a sectional view taken along the line A-A in FIG. 1, showing the upper part of the automotive rear window glazing, greatly enlarged. As stated above, the glazing is a laminated glazing, comprising first and second plies of glass 20, 21, with a ply of plastics interlayer material 22 (hereafter termed “interlayer” for brevity) extending between the plies of glass and bonding them together.

Automotive glazings are normally curved, with the convex surface facing the exterior, and the concave surface facing the interior of the vehicle. In the automotive industry, it is conventional to number the surfaces of the plies 1, 2, 3, 4, starting from the exterior surface. Accordingly the first ply 20 is the exterior ply, having surfaces 1 and 2, and the second ply 21 is the interior ply, having surfaces 3 and 4. In this specification, “interior” is used to denote the interior of the vehicle, and not the inside of the laminate.

The laminated glazing is manufactured in three steps: first the plies are assembled, then the assembly is de-aired, and finally the assembly is heated in an autoclave to bond the plies together to form a laminate. Accordingly, first the ply of plastics interlayer material is placed between the plies of glass so that it is in register with them, i.e. co-extensive with them, and then air is removed from the assembly by passing it between nip-rollers or by use of a vacuum bag. The de-aired assembly is then placed in an autoclave and subjected to an elevated temperature and pressure to cause the interlayer material to bond to the glass, thereby bonding the plies of glass together and forming a laminate.

The maximum temperature attained in the autoclave may be between 125° C. and 150° C., preferably 140° C., and the maximum pressure may be between 8 and 15 bars (between 0.8 and 1.5 MPa), preferably 12 bars (1.2 MPa). These conditions may be sustained for between 15 and 45 minutes, preferably around 30 minutes. The total autoclave cycle including heating and pressurisation may take around 90 minutes.

The interlayer material softens and flows while the glazing is in the autoclave, and it had previously been thought that any unevenness in the thickness of the interlayer material would dissipate during autoclaving, with the consequence that the draw lines would disappear. However, it has been found that this is not the case, and it is now believed that the wavelength of the draw lines is too large for the differences in thickness to homogenise during the time available during the autoclave cycle. Furthermore, extending the length of the autoclave cycle for the purpose of reducing the amplitude of the draw lines would not only add to costs, but it is also believed that as the interlayer material flows, distortion due to unevenness in the glass would be accentuated.

It should be noted that FIG. 2 is also schematic in nature. In particular, although the plies are shown as being of approximately equal thickness, normally at least one and possibly both plies of glass may be thicker than the interlayer. The plies of glass may range from 1.6 to 2.9 mm in thickness; alternatively, one of the plies of glass may be less than 1.5 mm in thickness, preferably in the range from 0.4 to 1.3 mm. When one of the plies is composed of chemically toughened glass, its thickness will normally be in the range from 0.4 to 1.3 mm, preferably 0.5 to 1.1 mm. If present, the chemically toughened ply is likely to be the inner ply.

FIG. 3 is a diagram showing the installation angle of the automotive rear window glazing, the glazing being shown in section. A tangent 30 is drawn to the glazing 10 in its installed condition, and the angle to the vertical 31 is measured, this being the installation angle 32.

FIG. 4 is a schematic combined perspective and sectional view of a sheet of plastics interlayer material 22, showing elongate peaks 40 and troughs 41 which extend in one direction, i.e. they all extend in a single direction. The peaks and troughs are therefore parallel to each other, as are the resulting draw lines in a laminated glass made with the interlayer.

It should be noted that FIG. 4 is purely diagrammatic, and shows the amplitude of the peaks and troughs greatly exaggerated, and the wavelength greatly compressed. The wavelength of the peaks and troughs is shown on the sectional part of FIG. 4, denoted by reference numeral 42.

Referring again to FIG. 1, when the glazing 10 is viewed in appropriate lighting conditions, such as a shadowgraph, transmitted optical distortion in the form of a pattern of faint parallel lines 15 may be seen extending from the top edge 11 to the bottom edge 12 (or vice versa, as will be clear). As previously mentioned, the lines 15 comprise alternating lines of relative brightness and darkness resulting from the localised refractive power of the laminated glazing, due to the elongate peaks and troughs in the interlayer. These alternating lines are the draw lines previously referred to. It is not possible to represent draw lines faithfully in a line drawing, and so dashed lines have been used in the absence of a better alternative.

The magnitude and extent of transmitted optical distortion may be accurately and quantitatively measured using equipment available from ISRA Vision AG, of Industriestrasse 14, D-64297 Darmstadt, Germany.

Such equipment may be used to evaluate the optical quality of a rear window glazing in the laboratory, and detect the degree of distortion present. However, as a consequence of the invention, this distortion is barely visible to the occupants of a vehicle in which a rear window glazing according to the invention is fitted.

1. An automotive rear window glazing for installation in a car, comprising at least two plies of glazing material and at least one ply of plastics interlayer material extending between the plies of glazing material, the ply of plastics interlayer material being substantially co-extensive with the plies of glazing material and bonding the plies of glazing material to each other, wherein the ply of plastics interlayer material contains draw lines extending in substantially one direction, the automotive rear window glazing has a top edge and a bottom edge, and wherein the automotive rear window glazing is installed with the draw lines in the plastics interlayer material extending from the top to the bottom edges.

2. An automotive rear window glazing as claimed in claim 1, wherein one or both of the plies of glazing material contains draw lines and the draw lines in the plies of glazing material are substantially parallel to the draw lines in the ply of plastics interlayer material.

3. An automotive rear window glazing as claimed in claim 1, wherein the installation angle of the glazing is 65° or greater.

4. An automotive rear window glazing as claimed in claim 1, wherein the installation angle of the glazing is 68° or greater.

5. An automotive rear window glazing as claimed in claim 1, wherein the installation angle of the glazing is 72° or greater.

6. An automotive rear window glazing as claimed in claim 1, wherein the installation angle of the glazing is 75° or greater.

7. An automotive rear window glazing as claimed in claim 1, wherein the installation angle of the glazing is 78° or greater.

8. An automotive rear window glazing as claimed in claim 1, wherein the thickness of at least one of the plies of glazing material is in the range from 0.4 to 1.3 mm.

9. An automotive rear window glazing as claimed in claim 1, wherein the thickness of at least one of the plies of glazing material is in the range from 0.5 to 1.1 mm.

10. An automotive rear window glazing as claimed in claim 1, wherein the thickness of at least one of the plies of glazing material is in the range from 0.6 to 0.9 mm.

11. An automotive rear window glazing as claimed in claim 1, wherein at least one of the plies of glazing material is glass which has been chemically toughened.

12. An automotive rear window glazing as claimed in claim 1, wherein the wavelength of the draw lines is 50 mm or greater.

13. An automotive rear window glazing as claimed in claim 1, wherein the wavelength of the draw lines is 80 mm or greater.

14. An automotive rear window glazing as claimed in claim 1, wherein the wavelength of the draw lines is 120 mm or greater.

15. A car fitted with an automotive rear window glazing as claimed in claim 1.

16. A high performance car fitted with an automotive rear window glazing as claimed in claim 1.
